(19) United States
(12) Patent Application Publication
(10) Pub. No.: US 2015/0291114 A1
(43) Pub. Date: Oct. 15, 2015

(54) Vehicle Bumper Beam, Associated Bumper Beam Assembly and Vehicle

(71) Applicant: Faurecia Bloc Avant, Nanterre (FR)

(72) Inventor: Patrick BORDE, Montbeliard (FR)

(21) Appl. No.: 14/679,386

(22) Filed: Apr. 6, 2015

(30) Foreign Application Priority Data
Apr. 9, 2014 (FR) 14 53160

(51) Int. Cl. B60R 19/30; B60R 19/03; B60R 19/02; B60R 19/34

(52) U.S. Cl. CPC B60R 19/30; B60R 19/34; B60R 19/03; B60R 19/023

(57) ABSTRACT

A vehicle bumper beam having a crosspiece and at least one shock absorber. The shock absorber supports the crosspiece when fastened on the absorber and it includes a plate designed to fasten the shock absorber on a structure of a vehicle. The shock absorber is made from a plastic material optionally reinforced with fibers. The bumper beam has at least one connecting member connecting the plate of the shock absorber to the crosspiece. The connecting member is able to hold the crosspiece at the plate after deformation of the absorber in case of impact.

### TECHNICAL FIELD

The present invention relates to a vehicle bumper beam, comprising:

a crosspiece, and

at least one shock absorber, the shock absorber being provided to support the crosspiece fastened on the absorber and comprising a plate designed to fasten the shock absorber on a structure of a vehicle, the shock absorber being made from a plastic material optionally reinforced with fibers.

### BACKGROUND OF THE INVENTION

Motor vehicles are designed to respond appropriately to different types of impacts, such as low-speed impacts or “parking impacts”, with a speed comprised between 2.5 and 4 km/h (ECE42), medium-speed impacts or “repairability impacts”, RCAR 16 km/h (Danner) and RCAR 10 km/h (Bumper Test), and high-speed impacts, with a speed comprised between 56 and 65 km/h.

To that end, the motor vehicles incorporate one or more bumper beams in a front or rear bumper assembly, bearing on bars of the motor vehicle. In case of impact, owing to their specific mechanical properties, these bumper beams deform so as to absorb at least part of the energy from the impact.

Thus, it is known to implement bumper beams made from steel sheets, which have good mechanical performance, but also a significant mass, contributing to increasing the total mass of the motor vehicle.

It is known to use shock absorbers made from composite plastic material in order to decrease the mass of the bumper beam and improve the absorption of the energy from the impact. However, there is a risk of disintegration of a bumper assembly made from a composite material during impacts.

### SUMMARY OF THE INVENTION

One aim of the invention is to propose a bumper beam with a reduced mass and reduced manufacturing costs that is able to effectively absorb the impact energy and makes it possible to preserve cohesion of the bumper assembly even after a significant impact.

To that end, the invention relates to a vehicle bumper beam of the aforementioned type, characterized in that the bumper beam also further comprises at least one connecting member connecting the plate of the shock absorber to the crosspiece, the connecting member being able to hold the crosspiece at the plate after deformation of the absorber in case of impact.

According to other embodiments, the bumper beam comprises one or more of the following features, considered alone or according to any technically possible combination(s):

the beam comprises two shock absorbers, each absorber being positioned at a respective end of the crosspiece;

the connecting member is plastically deformed during an impact;

the connecting member is a metal part fastened on the plate and on the crosspiece;

the connecting member is a flexible link fastened on the plate and on the crosspiece;

the connecting member is a braid.

The invention also relates to a bumper assembly comprising two structural bars each having an end and a bumper beam as defined above, comprising two shock absorbers each fastened on the end of a respective bar by its plate.

In one embodiment of the bumper assembly, the connecting member is able to keep the crosspiece relative to the structural bars of the vehicle at a distance smaller than approximately 100 mm downward, after deformation of the absorber in case of impact.

The invention also relates to a motor vehicle comprising a bumper assembly as defined above.

### BRIEF DESCRIPTION OF THE DRAWINGS

The invention and its advantages will be better understood upon reading the following description, provided solely as a non-limiting example, and done in reference to the appended drawings, in which:

FIG. 1 is a diagrammatic exploded perspective view of a bumper assembly according to the invention;

FIG. 2 is a perspective view of part of the bumper beam of FIG. 1, illustrating the shock absorber and connecting members;

FIG. 3 is a view similar to FIG. 2 illustrating a shock absorber and a connecting member according to another embodiment.

### DETAILED DESCRIPTION

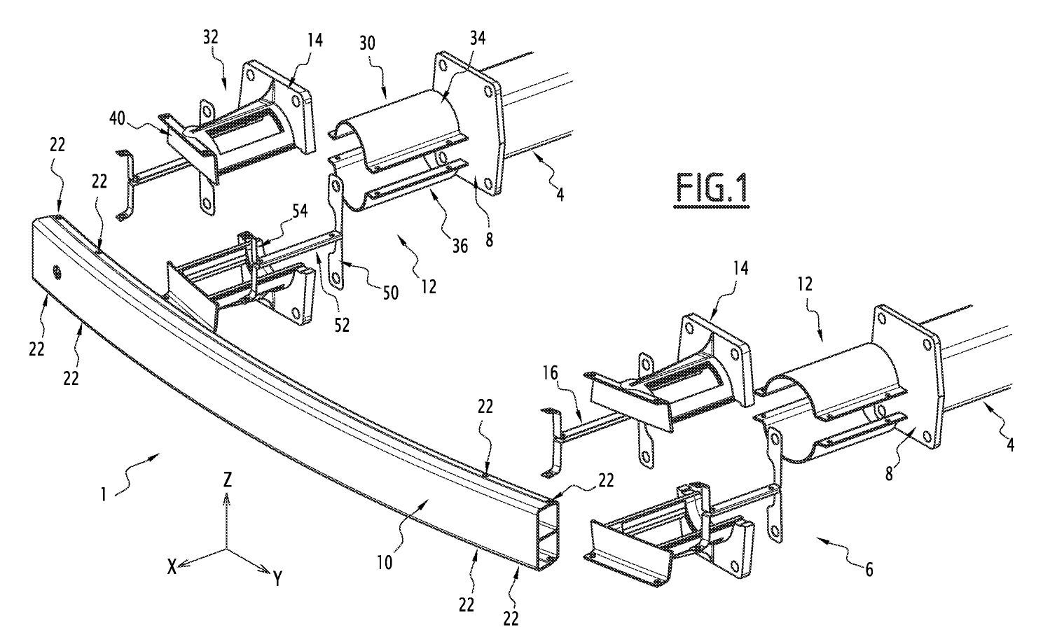

A vehicle bumper assembly 1, according to the invention, is shown in FIG. 1.

The bumper assembly 1 comprises a bumper beam 6 fastened to the ends of the two bars 4 of the body in white or structure of the vehicle, in particular a motor vehicle.

The terms “longitudinal”, “transverse”, “left”, “right”, “top”, “bottom” are used in reference to the orthogonal reference of the motor vehicles, comprising:

a longitudinal axis X, oriented from back to front,

a transverse axis Y, oriented from right to left, and

a vertical axis Z, oriented from bottom to top.

The bumper assembly 1 is either a front bumper assembly, in which case the bars 4 are bars of the front part of the structure, or a rear bumper assembly, in which case the bars 4 are bars of the rear part of the structure.

The bars 4 are main structural bars or auxiliary bars, such as front or rear engine cradle extensions or front or rear fender bars.

The bars 4 extend in the longitudinal direction, each following a respective longitudinal axis. The bars 4 are spaced apart in a transverse direction. Each bar 4 is provided at its end with a bar plate 8 for fastening the bumper beam 6 on the bar 4.

The bumper beam 6 comprises a crosspiece 10 and two shock absorbers 12. Each shock absorber 12 comprises a plate 14 designed to fasten the shock absorber 12 on a bar 4. The bumper beam 6 further comprises, for each shock absorber 12, at least one connecting member 16 connecting the plate 14 of the shock absorber 12 to the crosspiece 10.

The bumper beam 6 is designed to be fastened on the bars 4 using shock absorbers 12, each shock absorber 12 being fastened on and bearing on a respective bar 4 by means of the plate 14 of the absorber 12 and the bar plate 8.

The crosspiece 10 extends in the transverse direction. The crosspiece 10 bears in the longitudinal direction on the bars 4 by means of the shock absorbers 12.

The crosspiece 10 is advantageously hollow. The crosspiece 10 is for example made from metal, in particular steel.

The crosspiece 10 is provided on its upper face and lower face with a plurality of fastening holes 22 to fasten the crosspiece 10 to the connecting members 16. In the example shown in FIG. 1, the crosspiece comprises four holes 22 per shock absorber 12, the holes 22 making it possible to fasten the crosspiece 10 both to the absorber 12 and to the connecting members 16.

The transverse separation of the shock absorbers 12 is substantially equal to that of the bars 4. Each of the two shock absorbers 12 is fastened on the end of a respective bar 4 by means of its plate 14. Furthermore, each shock absorber 12 is positioned at a respective end of the crosspiece 10 and extends in the longitudinal direction. Each shock absorber 12 longitudinally extends the associated bar 4.

Each shock absorber 12 is made at least partially from a plastic material, optionally reinforced with fibers.

The shock absorber 12 is able to absorb the energy from an impact while deforming between an idle state and a crushed state. For significant impacts, the shock absorber 12 also absorbs energy by deteriorating. “Deteriorating” means that the shock absorber 12 no longer has its integrity, i.e., is no longer able to keep the crosspiece 10 in position relative to the bar 4.

The shock absorber 12 comprises an absorber element 30 and an enclosure 32. The enclosure 32 surrounds the absorber element 30.

The absorber element 30 is advantageously a hollow cylinder. The absorber element 30 is made from a plastic composite material, preferably a plastic material reinforced with long fibers, referred to as LCFRP. The absorber element 30 extends in the longitudinal direction X.

As illustrated in FIG. 1, the absorber element 30 is formed by two half-shells 34, 36. Each half-shell 34, 36 is semi-cylindrical in the longitudinal direction. Each half-shell 34, 36 is provided with two lateral rims for mutual fastening of the half-shells by joining their corresponding rims in pairs, and fastening the joined rims, for example using screws or rivets.

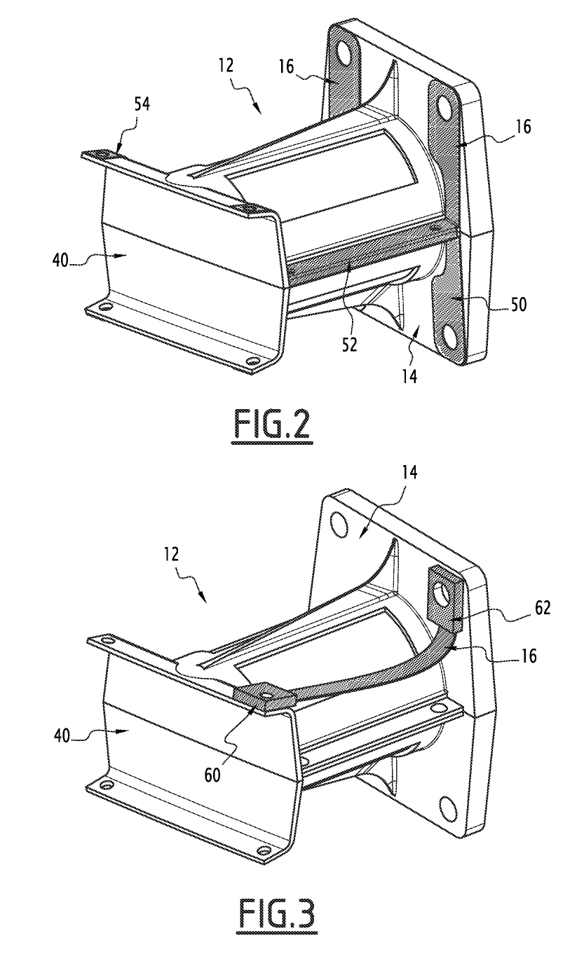

The enclosure 32 of the shock absorber 12 is made from a short-fiber reinforced plastic material. In the example illustrated in FIGS. 1 and 2, the enclosure 32 is formed by two half-enclosures, each covering a respective half-cylinder.

The surface of the absorber element 30 is solid. The enclosure 32 is openworked.

The plate 14 designed for fastening of the shock absorber 12 on a bar 4 is formed on the enclosure 32. The plate 14 comprises fastening holes.

Each shock absorber 12 is provided to support the crosspiece 10 fastened on the absorber 12. In the example illustrated in FIGS. 1 and 2, the absorber 12 comprises, on its enclosure 32, a crosspiece fastening support 40, pierced on its lower and upper surface across from the fastening holes 22 of the crosspiece 10. The support 40 defines a U-shaped profile oriented transversely, the crosspiece 10 being received in the support 40.

In the illustrated example, two connecting members 16 are positioned on each shock absorber 12.

Each connecting member 16 is able to deform without breaking in case of impact affecting the shock absorber 12, such that the shock absorber 12 no longer supports the crosspiece 10.

Each connecting member 16 forms an auxiliary support to support the crosspiece 10 in case of damage to the absorber 12 such that the absorber 12 no longer supports the crosspiece 10.

Each connecting member 16 is able to keep the crosspiece 10 at the plate 14 after deformation of the absorber in case of impact, at a vertical distance of less than approximately 100 mm downward, after deformation of the absorber in case of impact 12.

In the example shown in FIGS. 1 and 2, the connecting member 16 is a metal part fastened on the plate 14 and on the crosspiece 10.

The connecting member 16 comprises a first fastening part 50, a central connecting part 52 and a second fastening part 54.

The first fastening part 50 is fastened on the plate 14.

The rear fastening part 50 extends in a vertical direction Z and defines two holes across from the holes of the plate 14.

The first fastening part 50 is designed to link the connecting member 16 to the plate 14.

The central connecting part 52 extends in the longitudinal direction X along the absorber element. It defines a trough in which two joint adjacent rims of the half-shells are inserted. The central connector part 52 overlaps the two joined rims. The central connecting part 52 makes it possible to seal the absorbing element 30.

The second fastening part 54 is fastened to the crosspiece.

The second fastening part 54 extends in the vertical direction Z. It comprises, at its ends, returns extending in the longitudinal direction. The returns are pierced across from the holes 22 of the crosspiece 10. The second fastening part 54 is designed to link the crosspiece 10 and the fastening support 40 of the shock absorber 12 to the connecting member 16.

The connecting member 16 is deformed plastically during an impact. It is less fragile than the shock absorber 12. The connecting member 16 is able to deform easily without breaking The shock absorber 12 is able to compress under a maximal crushing force. The connecting member 16 is able to compress under a force of less than 1/100 of the maximum crushing force. For example, the connecting member 16 is able to compress longitudinally under a force of less than 1 kN, for example less than approximately 100 N. The absorber 12 is able to deform longitudinally under a force of less than 100 kN.

The connecting member 16 remains in a single piece after the impact and is thus able to retain the crosspiece 10. In fact, the first fastening part 50, the second fastening part 54 and the central part 50 remain secured.

The connecting member 16 secures the plate 14 of the shock absorber 12 to the crosspiece 10, such that the connecting member 16 is able to keep the crosspiece 10 secured to the plate 12 in place of the shock absorber 12, when the shock absorber 12 is deteriorated.

The operation of the device will now be described.

When a significant impact of the vehicle occurs, the shock absorber 12 deteriorates. However, the connecting members 16 maintain cohesion of the assembly of the bumper unit 1 and link the plate 14 to the crosspiece 10. The connecting members 16 thus prevent the crosspiece 10 from falling on the ground, even if it is no longer held by the shock absorber 12. This allows the vehicle to travel to reach a garage for repairs.

Another embodiment of the invention will now be described, in light of FIG. 3. This embodiment differs from the previously described embodiment in that the connecting member 16 is a flexible link fastened on the plate 14 and on the crosspiece 10 by fastening ends 60 and 62. For example, the connecting member 16 is a braid, in particular a metal or textile braid.

The length of the link, when it is stretched, is advantageously close to the length of the absorber 12.

During or after deformation of the absorber 12 in case of impact, if the absorber 12 is no longer able to hold the crosspiece 10, the crosspiece 10 stretches the flexible link under the effect of its weight. The crosspiece 10 is suspended from the bar by the connecting member 16. The connecting member 16 then keeps the crosspiece 10 relative to the structural bars 4 of the vehicle at a distance smaller than approximately 100 mm downward, after deformation of the absorber 12 in case of impact. The connecting member 16 holds the crosspiece 10 so as to prevent it from touching the ground.

The embodiments described above provide a bumper beam 6 with a reduced mass and lower manufacturing cost, and which can effectively absorb the energy from impacts and makes it possible to preserve an assembled form of the bumper unit 1 even after a significant impact.

1. A vehicle bumper beam, comprising:
a crosspiece, and
at least one shock absorber, the shock absorber being provided to support the crosspiece fastened on the absorber and comprising a plate designed to fasten the shock absorber on a structure of a vehicle, the shock absorber being made from a plastic material,
wherein the bumper beam further comprises at least one connecting member connecting the plate of the shock absorber to the crosspiece, the connecting member being able to hold the crosspiece to the plate after deformation of the absorber in case of impact.

2. The bumper beam according to claim 1, comprising two shock absorbers, each absorber being positioned at a respective end of the crosspiece.

3. The bumper beam according to claim 1, wherein the connecting member is plastically deformed during an impact.

4. The bumper beam according to claim 3, wherein the connecting member is a metal part fastened on the plate and on the crosspiece.

5. The bumper beam according to claim 1, wherein the connecting member is a flexible link fastened on the plate and on the crosspiece.

6. The bumper beam according to claim 5, wherein the connecting member is a braid.

7. The bumper beam according to claim 1, wherein the connecting member is able to compress under a force of less than 100 N.

8. The bumper beam according to claim 1, wherein the shock absorber comprises a hollow absorber element formed by two half-shells provided with corresponding rims for mutual fastening of the half-shells by joining their corresponding rims, and the connecting member comprises at least one trough in which two joined rims of the two half-shells are inserted.

9. The bumper beam according to claim 8, wherein the shock absorber comprises an enclosure surrounding the absorber element.

10. The bumper beam according to claim 1, wherein the shock absorber is able to compress under a maximal crushing force, and the connecting member is able to compress under a force of less than 1/100 of the maximal crushing force.

11. The bumper beam according to claim 1, wherein the plastic material is reinforced with fibers.

12. A bumper assembly comprising two structural bars each having an end and a bumper beam according to claim 1, comprising two shock absorbers each fastened on the end of a respective bar by its plate.

13. The assembly according to claim 12, wherein the connecting member is able to keep the crosspiece relative to the structural bars of the vehicle at a distance smaller than approximately 100 mm downward, after deformation of the absorber in case of impact.

14. A vehicle comprising a bumper assembly according to claim 12.
